(19) United States
(12) Patent Application Publication
(10) Pub. No.: US 2026/0288653 A1
(43) Pub. Date: Sep. 24, 2026

(54) VIRTUAL BLOCK STRUCTURE FOR RANDOM READ OPERATIONS

(71) Applicant: Micron Technology, Inc., Boise, ID (US)

(72) Inventors: Deping He, Boise, ID (US); Caixia Yang, Boise, ID (US)

(21) Appl. No.: 19/564,828

(22) Filed: Mar. 12, 2026

Related U.S. Application Data
(60) Provisional application No. 63/775,256, filed on Mar. 20, 2025.

(51) Int. Cl. G06F 12/109

(52) U.S. Cl. CPC G06F 12/109

(57) ABSTRACT

Methods, systems, and devices for virtual block structure for random read operations are described. A memory system may implement sub-virtual blocks within each virtual block of the memory system. To use an implemented sub-virtual block architecture, the memory system may write to a first sub-virtual block of a virtual block before writing to a second sub-virtual block of the virtual block. The memory system may perform various access operations at the non-volatile memory of the memory system by accessing the first sub-virtual block or the second sub-virtual block of the virtual block. In some examples, after writing to and reading from the sub-virtual blocks, the memory system may perform an erase operation on all sub-virtual blocks of the virtual block simultaneously.

### CROSS REFERENCE

The present Application for Patent claims priority to U.S. Patent Application No. 63/775,256 by He et al., entitled “VIRTUAL BLOCK STRUCTURE FOR RANDOM READ OPERATIONS,” filed Mar. 20, 2025, which is assigned to the assignee hereof, and which is expressly incorporated by reference in its entirety herein.

### TECHNICAL FIELD

The following relates to one or more systems for memory, including virtual block structure for random read operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports a virtual block structure for random read operations in accordance with examples as disclosed herein.

FIG. 2 shows an example of a block diagram that supports a virtual block structure for random read operations in accordance with examples as disclosed herein.

FIG. 3 shows an example of a process that supports a virtual block structure for random read operations in accordance with examples as disclosed herein.

FIG. 4 shows a block diagram of a memory system that supports a virtual block structure for random read operations in accordance with examples as disclosed herein.

FIG. 5 shows a flowchart illustrating a method or methods that support a virtual block structure for random read operations in accordance with examples as disclosed herein.

### DETAILED DESCRIPTION

Some memory systems may include relatively large quantities of non-volatile memory, such as a relatively large quantity of non-volatile memory dies. In some examples, each of the memory dies may be associated with multiple virtual blocks that may be associated with (e.g., correspond to) respective physical blocks of non-volatile memory cells. For example, a single virtual block may be associated with (e.g., span) half of the memory dies of the memory system. In some examples, the memory system may be configured to access (e.g., read, randomly read) a virtual block while performing testing operations (e.g., benchmark testing) on memory cells corresponding to the virtual block(s). For example, in the case that a virtual block may be associated with eight memory dies, the memory system may concurrently read memory cells of the eight memory dies during a sequential read operation.

During a write operation, the memory system may write to each memory cell of the eight memory dies of the virtual block. Reading from and writing to all memory dies of a virtual block may increase operational latency at and decrease efficiency of the memory system. Additionally, or alternatively, during a random read operation, the memory system may only be able to read data from a single virtual block at a time (e.g., rather than from multiple virtual blocks concurrently), which may decrease performance of the memory system. Further, such memory systems may include a relatively low quantity of volatile memory. With limited quantities of volatile memory and high quantities of non-volatile memory, the memory system may associate a higher density of memory dies (e.g., sixteen memory dies) with a single virtual block, which may further decrease the performance and efficiency of the memory system, while increasing its power consumption.

To increase performance and efficiency of a memory system while decreasing its power usage, an associated memory system may implement sub-virtual blocks. For example, a sub-virtual block may span relatively fewer memory dies than a virtual block of a conventional memory system. To implement a sub-virtual block architecture, the memory system may write to a first sub-virtual block of a virtual block before writing to a second sub-virtual block of the virtual block. The memory system may perform various access operations at the non-volatile memory of the memory system by accessing the first sub-virtual block or the second sub-virtual block of the virtual block (e.g., sequential reads, random reads, write operations). In some examples, after writing to and reading from the sub-virtual blocks, the memory system may perform an erase operation at both (e.g., all) sub-virtual blocks of the virtual block simultaneously.

Increasing the granularity at which a memory system may access a relatively large quantity of memory dies may decrease power usage at and improve performance of the memory system. For example, use of sub-virtual blocks may increase random read performance at the memory system by increasing a quantity of data that may be accessed during a read operation (e.g., a random read operation). In the case that a relatively large quantity of memory dies may be associated with two sub-virtual blocks (e.g., of a single virtual block), and the two sub-virtual blocks may be consecutively written to during a write operation, the memory system may read from both sub-virtual blocks concurrently during a benchmark test (e.g., a random read benchmark test), which may increase the overall performance of the memory system.

In addition to applicability in memory systems as described herein, virtual block structures for random read operations may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing accesses of the electronic devices, which may extend the life of electronic devices and thereby reducing electronic waste, among other benefits.

Features of the disclosure are illustrated and described in the context of systems, devices, and circuits. Features of the disclosure are further illustrated and described in the context of block diagrams, processes, and flowcharts.

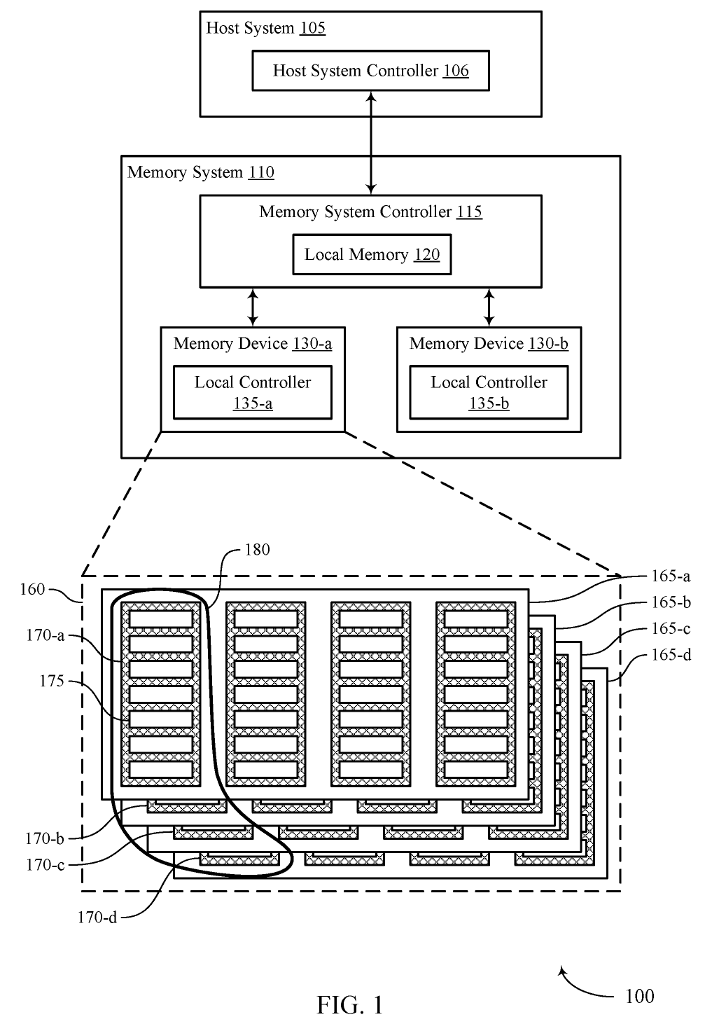

FIG. 1 shows an example of a system 100 that supports a virtual block structure for random read operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may include relatively large quantities of non-volatile memory, such as a relatively large quantity of non-volatile memory dies 160. In some examples, each of the memory dies may be associated with multiple virtual blocks 180 that may be associated with (e.g., correspond to) respective physical blocks of non-volatile memory cells. For example, a single virtual block 180 may be associated with (e.g., span) half of the memory dies 160 of the memory system 110. In some examples, the memory system 110 may be configured to access (e.g., read, randomly read) a virtual block 180 while performing testing operations (e.g., benchmark testing) on memory cells corresponding to the virtual block(s). For example, in the case that a virtual block 180 may be associated with eight memory dies 160, the memory system 110 may concurrently read memory cells of the eight memory dies 160 during a sequential read operation.

During a write operation, the memory system 110 may write to each memory cell of the eight memory dies 160 of the virtual block 180. Reading from and writing to all memory dies 160 of a virtual block 180 may increase operational latency at and decrease efficiency of the memory system 110. Additionally, or alternatively, during a random read operation, the memory system 110 may only be able to read data from a single virtual block at a time (e.g., rather than from multiple virtual blocks 180 concurrently), which may decrease performance of the memory system 110. Further, such memory systems may include a relatively low quantity of volatile memory. With limited quantities of volatile memory and high quantities of non-volatile memory, the memory system 110 may associate a higher density of memory dies 160 (e.g., sixteen memory dies 160) with a single virtual block 180, which may further decrease the performance and efficiency of the memory system 110, while increasing its power consumption.

To increase performance and efficiency of a memory system 110 while decreasing its power usage, the memory system 110 may implement sub-virtual blocks. For example, a sub-virtual block may span relatively fewer memory dies 160 than a virtual block 180 of a conventional memory system 110. To implement a sub-virtual block architecture, the memory system 110 may write to a first sub-virtual block of a virtual block 180 before writing to a second sub-virtual block of the virtual block 180. The memory system 110 may perform various access operations at the non-volatile memory of the memory system 110 by accessing the first sub-virtual block or the second sub-virtual block of the virtual block 180 (e.g., sequential reads, random reads, write operations). In some examples, after writing to and reading from the sub-virtual blocks, the memory system 110 may perform an erase operation at both (e.g., all) sub-virtual blocks of the virtual block 180 simultaneously.

Increasing the granularity at which a memory system 110 may access a relatively large quantity of memory dies 160 may decrease power usage at and improve performance of the memory system 110. For example, use of sub-virtual blocks may increase random read performance at the memory system 110 by increasing a quantity of data that may be accessed during a read operation (e.g., a random read operation). In the case that a relatively large quantity of memory dies 160 may be associated with two sub-virtual blocks (e.g., of a single virtual block 180), and the two sub-virtual blocks may be consecutively written to during a write operation, the memory system 110 may read from both sub-virtual blocks concurrently during a benchmark test (e.g., a random read benchmark test), which may increase the overall performance of the memory system 110.

The system 100 may include any quantity of non-transitory computer readable media that support virtual block structure for random read operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

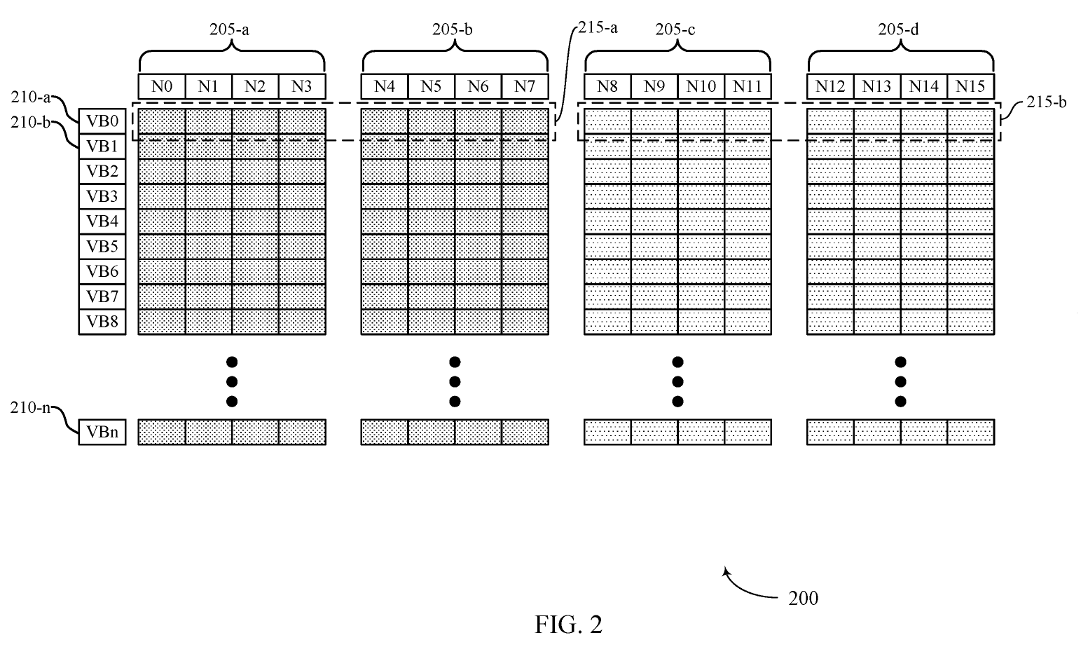

FIG. 2 shows an example of a block diagram 200 that supports a virtual block structure for random read operations in accordance with examples as disclosed herein. The block diagram 200 may illustrate a virtual block architecture implemented by a system 100 as described with reference to FIG. 1. For example, the block diagram 200 may include sets of memory dies 205 (e.g., a set of memory dies 205-a, a set of memory dies 205-b, a set of memory dies 205-c, a set of memory dies 205-d) which may each include one or more non-volatile memory dies, which may be examples of dies 160 as described herein with reference to FIG. 1. In some examples, each of the sets of memory dies 205 may include four non-volatile memory dies (e.g., NAND dies). For example, the set of memory dies 205-a may include memory dies N0–N3, the set of memory dies 205-b may include memory dies N4–N7, the set of memory dies 205-c may include memory dies N8–N11, and the set of memory dies 205-d may include memory dies N12–N15. In other examples, each of the sets of memory dies 205 may include other quantities of memory dies. The block diagram 200 may also include one or more virtual blocks 210, which may be examples of virtual blocks 180 as described herein with reference to FIG. 1. While FIG. 2 illustrates a specific quantity of the sets of memory dies 205 and the one or more virtual blocks 210, other examples may include any quantity of the sets of memory dies 205 and the one or more virtual blocks 210, respectively.

A memory system may include one or more memory devices that may include sets of memory dies 205 and a controller which may be configured to perform access operations at each of the sets of memory dies 205. For example, a memory system controller 115 as described with reference to FIG. 1 may perform one or more access operations at one or more of the sets of memory dies 205. A controller of the memory system may perform various access operations (e.g., read operations, write operations, erase operations) at the sets of memory dies 205 of the block diagram 200 in response to receiving various commands. The virtual blocks 210 may be associated with one or more portions of memory dies of the sets of memory dies 205 such that the memory system (e.g., the controller thereof) may perform access operations on multiple memory dies simultaneously, as further discussed herein with reference to FIG. 1.

In some examples, a memory system may implement sub-virtual blocks 215. For example, a sub-virtual block 215 may span relatively fewer memory dies than a virtual block 210. To implement a sub-virtual block architecture, the memory system may write to a first sub-virtual block 215-a of a virtual block 210 before writing to a second sub-virtual block 215-b of the virtual block 210. The first sub-virtual block 215-a may be associated with, for example, memory dies N0–N7 and the second sub-virtual block 215-b may be associated with, for example, memory dies N8–N15. The memory system may perform various access operations at the non-volatile memory of the memory system by accessing the first sub-virtual block 215-a or the second sub-virtual block 215-b of the virtual block 210 (e.g., sequential reads, random reads, write operations). In some examples, after writing to and reading from the sub-virtual blocks 215, the memory system may perform an erase operation at both (e.g., all) sub-virtual blocks 215 of the virtual block 210 simultaneously.

Increasing the granularity at which a memory system may access a relatively large quantity of memory dies may decrease power usage at and improve performance of the memory system. For example, use of sub-virtual blocks 215 may increase random read performance at the memory system by increasing a quantity of data that may be accessed during a read operation (e.g., a random read operation). In the case that a relatively large quantity of memory dies may be associated with two sub-virtual blocks 215 (e.g., of a single virtual block 210), and the two sub-virtual blocks 215 may be consecutively written to during a write operation, the memory system may read from both sub-virtual blocks 215 concurrently during a benchmark test (e.g., a random read benchmark test), which may increase the overall performance of the memory system.

In some examples, the memory system may be configured to access (e.g., read, randomly read) a virtual block 210 while performing testing operations (e.g., benchmark testing) on memory cells corresponding to the virtual block(s). For example, in the case that a virtual block 210 is associated with sixteen memory dies, the memory system may read memory cells of the sixteen memory dies during a sequential read operation. During a write operation, the memory system may concurrently write to each memory cell of the sixteen memory dies of the virtual block 210. Traditionally, reading from and writing to all memory dies of a virtual block 210 may increase latency at and decrease the efficiency of the memory system. Additionally, or alternatively, during a random read operation, the memory system may only be able to read data from each virtual block 210 at a time (e.g., rather than from multiple virtual blocks concurrently), which may decrease performance of the memory system. Further, such memory systems may include a relatively low quantity of volatile memory. With limited quantities of volatile memory and high quantities of non-volatile memory, the memory system may associate a higher density of memory dies (e.g., sixteen memory dies) with a single virtual block 210, which may further decrease the performance and efficiency of the memory system, while increasing its power consumption.

To increase efficiency of the memory system and decrease power usage associated with virtual blocks 210 that may be associated with (e.g., span) large quantities of non-volatile memory dies, the memory system may implement sub-virtual blocks 215 within each virtual block 210 of the block diagram 200. For example, each virtual block 210 may include at least two sub-virtual blocks 215, and each sub-virtual block 215 may be associated with a portion of the sets of memory dies 205 corresponding to the respective virtual block 210. Each sub-virtual block 215 may be associated with a same quantity of the sets of memory dies 205, and may each be associated with different sets of memory dies 205. For example, the virtual block 210 may be associated with a sub-virtual block 215-a and a sub-virtual block 215-b, where the sub-virtual block 215-a may be associated with a first half of the portion of memory dies associated with the virtual block 210-a (e.g., the set of memory dies 205-a and the set of memory dies 205-b) and the sub-virtual block 215-b may be associated with a second half of the portion of memory dies associated with the virtual block 210-a (e.g., the set of memory dies 205-c and the set of memory dies 205-d). In some other examples, each of the virtual blocks 210 may be associated with more than two sub-virtual blocks 215 (e.g., not illustrated).

The memory system may write to the sub-virtual blocks 215 according to an order (e.g., a sequential order). For example, in response to receiving a write command (e.g., or other access command) to write to the memory dies associated with the virtual block 210-a, the controller of the memory system may first write to the sets of memory dies 205 associated with the sub-virtual block 215-a (e.g., the set of memory dies 205-a and the set of memory dies 205-b). Once the sub-virtual block 215-a is written to (e.g., fully stored to), the controller may write to the sets of memory dies 205 associated with the sub-virtual block 215-b (e.g., the set of memory dies 205-c and the set of memory dies 205-d). In some examples, the controller may write to the sub-virtual block 215-a during a first duration and may write to the sub-virtual block 215-b during a second duration that may not be overlapping in time. In examples where a virtual block 210 may be associated with more than two sub-virtual blocks 215, the controller may write data to the sub-virtual blocks 215 consecutively, starting with writing to a first sub-virtual block 215 and writing to a second sub-virtual block 215 when the first sub-virtual block 215 is written to (e.g., full).

The memory system may sequentially read from the sub-virtual blocks 215. In response to receiving a sequential read command to read from a memory die associated with a virtual block 210, the controller of the memory system may read from a sub-virtual block 215 of the virtual block 210 associated with the memory die. For example, the memory system may receive a command to perform a sequential read operation on a portion of a memory die included in the set of memory dies 205-a and associated with the virtual block 210-a. In response to the command, the controller may read from the memory die by accessing the sub-virtual block 215-a.

The memory system may randomly read from a virtual block 210 using the sub-virtual blocks 215. In response to receiving a command to perform a random read operation at one or more memory dies of the sets of memory dies 205 associated with a virtual block 210, the controller may read from memory dies associated with both sub-virtual blocks 215 of the respective virtual block 210. For example, to perform a random read operation on portions of memory dies of the sets of memory dies 205 associated with the virtual block 210-a, the controller may read from the sub-virtual block 215-a and the sub-virtual block 215-b concurrently (e.g., simultaneously, within a same duration, within at least partially overlapping durations). Each random read operation may include the controller accessing each memory die of the sets of memory dies 205 (e.g., portions of each memory die) via the respective sub-virtual blocks 215.

Increasing the granularity at which the memory system may access a relatively large quantity of memory dies (e.g., the sets of memory dies 205) may improve performance of random read operations at the memory system. Use of the sub-virtual blocks 215 may increase random read performance at the memory system by increasing a quantity of memory dies that may be accessed during a single random read operation. For example, the memory system may read from both the sub-virtual block 215-a and the sub-virtual block 215-b of the virtual block 210-a during a random read of a benchmark test operation, which may increase performance of the random read operation.

The memory system may erase data from memory dies associated with a virtual block 210 using the sub-virtual blocks 215. In response to receiving a command to perform an erase operation at one or more memory dies of the sets of memory dies 205 associated with a virtual block 210, the controller may erase data from memory dies associated with both sub-virtual blocks 215 of the respective virtual block 210. For example, to perform an erase operation on portions of memory dies of the sets of memory dies 205 associated with the virtual block 210-a, the controller may erase data from the sub-virtual block 215-a and the sub-virtual block 215-b concurrently (e.g., simultaneously, within a same duration, within at least partially overlapping durations). In some other examples, the controller may erase data from the virtual block 210-a during a first duration and may erase data from the virtual block 210-b during a duration that is consecutive to the first duration. Each erase operation may include the controller removing (e.g., deleting) data from each memory die of the sets of memory dies 205 (e.g., portions of each memory die) via the respective sub-virtual blocks 215.

Increasing the granularity at which a memory system may access a virtual block 210 associated with a large quantity of memory dies may decrease power usage at the memory system while retaining efficiency and improving performance. For example, use of the sub-virtual blocks 215 may enable the memory system to quickly perform random read operations at portions of the sets of memory dies 205 without decreasing performance of the memory system, as each memory die of the block diagram 200 may be read from concurrently. Additionally, or alternatively, performing access operations at the sets of memory dies 205 using the sub-virtual blocks 215 may decrease overall access operations at the memory dies, which may decrease volatile memory usage and increase the lifetime of the sets of memory dies 205.

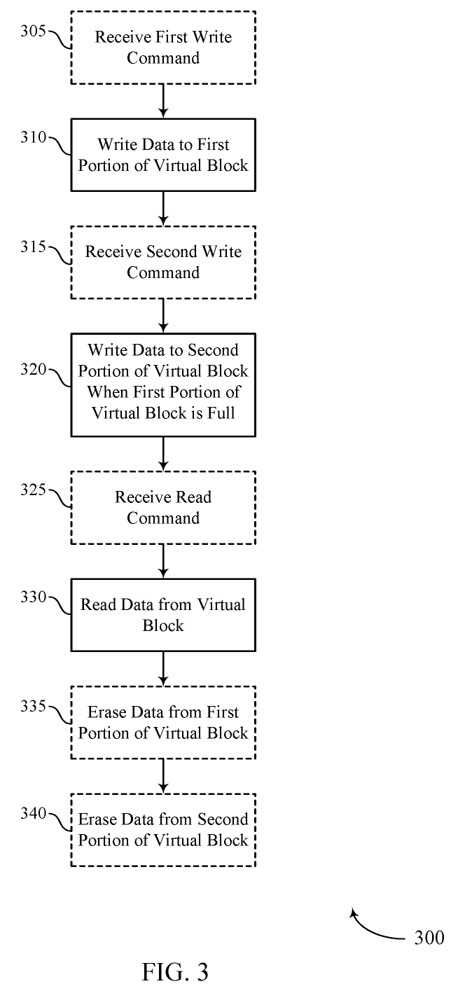

FIG. 3 shows an example of a process 300 that supports a virtual block structure for random read operations in accordance with examples as disclosed herein. The operations of process 300 may be performed by a memory system or one or more controllers associated with a memory system as described herein. For example, the operations of process 300 may be performed by a memory system 110 or a controller thereof as described with reference to FIG. 1. The process 300 may also include reference to memory dies, virtual blocks and sub-virtual blocks, which may be examples of dies 160, memory dies 205, virtual blocks 180, virtual blocks 210, and sub-virtual blocks 215, respectively, as described with reference to FIGS. 1 and 2.

At 305, a first write command may be received. For example, the memory system may receive a first write command from a host system. The first write command may command the memory system (e.g., a controller of the memory system, such as a memory system controller 115 as described with reference to FIG. 1) to write data to a first portion (e.g., a sub-virtual block) of a virtual block of the memory system. In some examples, the virtual block may be associated with multiple non-volatile memory dies of the memory system, and may be associated with two sub-virtual blocks.

At 310, data may be written to a first portion of a virtual block. For example, the memory system controller may write first data (e.g., associated with the first write command) to a first portion (e.g., a first sub-virtual block) of a virtual block of the memory system. In some examples, the memory system controller may write the first data to the first sub-virtual block in response to (e.g., in accordance with) receiving the first write command.

At 315, a second write command may be received. For example, the memory system may receive a second write command from a host system. The second write command may command the memory system controller to write data to a second portion (e.g., a sub-virtual block) of the virtual block of the memory system. The second portion of the virtual block may be associated with a same quantity of memory dies that the first portion of the virtual block may be associated with. Additionally, or alternatively, the first portion of the virtual block and the second portion of the virtual block may be associated with two different subsets of the memory dies of the memory system. For example, the first portion of the virtual block may be associated with a first set of eight memory dies of the memory system and the second portion of the virtual block may be associated with a second set of eight memory dies of the memory system that may be different from the first set of eight memory dies.

At 320, data may be written to a second portion of a virtual block. For example, the memory system controller may write second data (e.g., associated with the second write command) to a second portion (e.g., a second sub-virtual block) of the virtual block of the memory system. In some examples, the memory system controller may write the second data to the second sub-virtual block in response to (e.g., in accordance with) writing to the first sub-virtual block and receiving the second write command. The memory system controller may write the second data to the second portion of the virtual block after the first portion of the virtual block is fully written to (e.g., filled with data).

At 325, a read command may be received. For example, after writing the second data to the second portion of the virtual block, the memory system may receive a read command from the host system. The read command may be an example of a random read command and may be associated with the virtual block. In other examples, the read command may be an example of a sequential read command.

At 330, data may be read from the virtual block. For example, in response to receiving the read command and after writing the second data to the second portion of the virtual block, the memory system controller may read data associated with the read command from the virtual block. To read the data from the virtual block, the memory system controller may read the first data from the first portion of the virtual block and may read the second data from the second portion of the virtual block. The memory system controller may read the first data and the second data from each memory die of the multiple memory dies associated with the virtual block. In the case that the read command may be an example of a random read command, the memory system controller may read the first data from the first portion of the virtual block and may read the second data from the second portion of the virtual block in accordance with a random read operation. In the case that the read command may be an example of a sequential read command, the memory system controller may read the first data form the first portion of the virtual block in accordance with a first sequential read operation, and may read the second data from the second portion of the virtual block in accordance with a second sequential read operation different than the first sequential read operation.

At 335, data may be erased from the first portion of the virtual block. For example, the memory system controller may erase the first data from the first portion of the virtual block. In some examples, the memory system controller may perform the erase operation in response to receiving an erase command, after performing one or more read operations, or a combination thereof.

At 340, data may be erased from a second portion of the virtual block. For example, after erasing the first data from the first portion of the virtual block, the memory system controller may erase the second data from the second portion of the virtual block. In some examples, the memory system controller may erase the data from the virtual block as part of a single maintenance operation. For example, the memory system controller may erase the first data from the first portion of the virtual block during a first portion of a maintenance operation and may erase the second data from the second portion of the virtual block during a second portion of the maintenance operation.

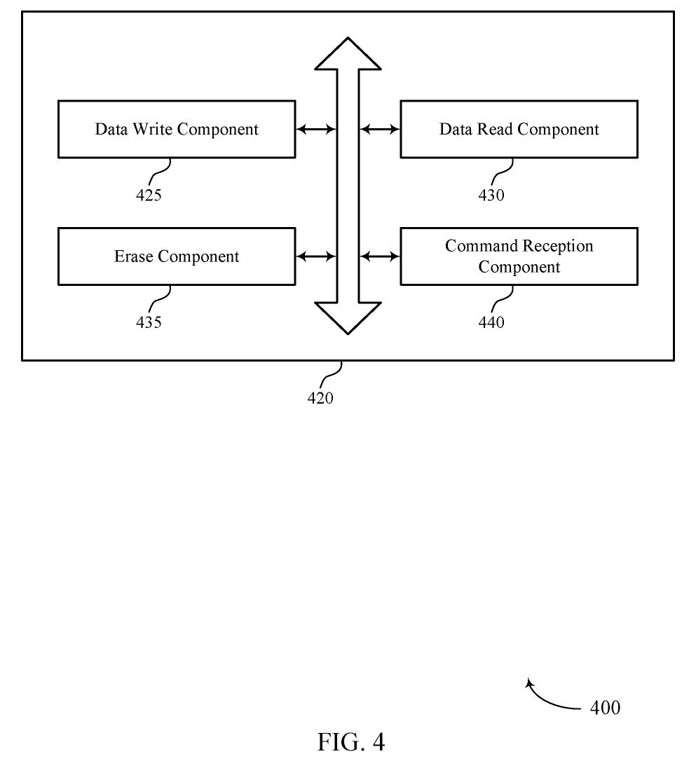

FIG. 4 shows a block diagram 400 of a memory system 420 that supports a virtual block structure for random read operations in accordance with examples as disclosed herein. The memory system 420 may be an example of aspects of a memory system as described with reference to FIGS. 1 through 3. The memory system 420, or various components thereof, may be an example of means for performing various aspects of virtual block structure for random read operations as described herein. For example, the memory system 420 may include a data write component 425, a data read component 430, an erase component 435, a command reception component 440, or any combination thereof. Each of these components, or components of subcomponents thereof (e.g., one or more processors, one or more memories), may communicate, directly or indirectly, with one another (e.g., via one or more buses).

The data write component 425 may be configured as or otherwise support a means for writing first data to a first portion of a virtual block of the memory system, the virtual block associated with a plurality of non-volatile memory dies of the memory system. In some examples, the data write component 425 may be configured as or otherwise support a means for writing second data to a second portion of the virtual block of the memory system in accordance with writing the first data to the first portion of the virtual block. The data read component 430 may be configured as or otherwise support a means for reading, in accordance with a random read operation, the first data from the first portion of the virtual block and the second data from the second portion of the virtual block after writing the second data to the second portion of the virtual block.

In some examples, reading the first data from the first portion of the virtual block and the second data from the second portion of the virtual block includes reading respective portions of the first data and the second data from each memory die of the plurality of non-volatile memory dies associated with the virtual block.

In some examples, the erase component 435 may be configured as or otherwise support a means for erasing the first data from the first portion of the virtual block and the second data from the second portion of the virtual block as part of a single maintenance operation.

In some examples, to support erasing the first data from the first portion of the virtual block and the second data from the second portion of the virtual block, the erase component 435 may be configured as or otherwise support a means for erasing the first data from the first portion of the virtual block during a first portion of the single maintenance operation. In some examples, to support erasing the first data from the first portion of the virtual block and the second data from the second portion of the virtual block, the erase component 435 may be configured as or otherwise support a means for erasing the second data from the second portion of the virtual block during a second portion of the single maintenance operation.

In some examples, the data read component 430 may be configured as or otherwise support a means for reading, in accordance with a first sequential read operation, the first data from the first portion of the virtual block. In some examples, the data read component 430 may be configured as or otherwise support a means for reading, in accordance with a second sequential read operation different than the first sequential read operation, the second data from the second portion of the virtual block.

In some examples, the command reception component 440 may be configured as or otherwise support a means for receiving a first write command, where writing the first data to the first portion of the virtual block is in accordance with receiving the first write command. In some examples, the command reception component 440 may be configured as or otherwise support a means for receiving a second write command, where writing the second data to the second portion of the virtual block is in accordance with receiving the second write command.

In some examples, the command reception component 440 may be configured as or otherwise support a means for receiving a random read command after writing the second data to the second portion of the virtual block, where reading the first data from the first portion of the virtual block and the second data from the second portion of the virtual block is in accordance with receiving the random read command.

In some examples, the first portion of the virtual block and the second portion of the virtual block are each associated with a respective subset of the plurality of non-volatile memory dies of the memory system.

In some examples, each respective subset of the plurality of non-volatile memory dies of the memory system includes a same quantity of memory dies.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

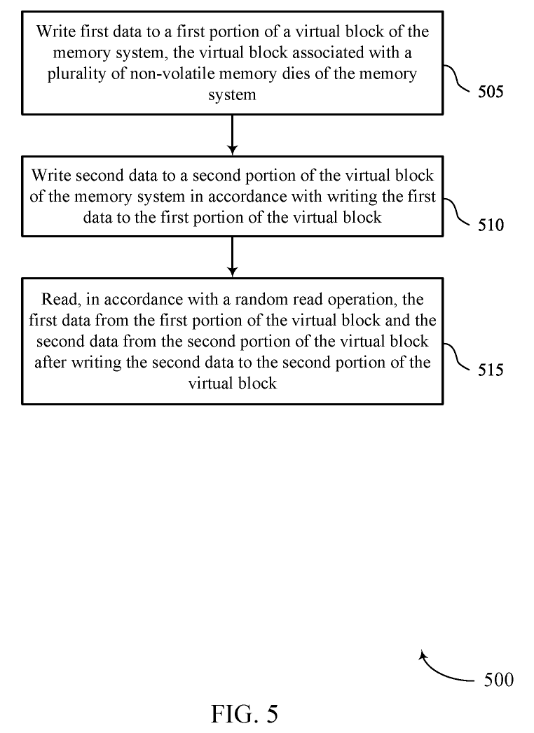

FIG. 5 shows a flowchart illustrating a method 500 that supports a virtual block structure for random read operations in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include writing first data to a first portion of a virtual block of the memory system, the virtual block associated with a plurality of non-volatile memory dies of the memory system. In some examples, aspects of the operations of 505 may be performed by a data write component 425 as described with reference to FIG. 4.

At 510, the method may include writing second data to a second portion of the virtual block of the memory system in accordance with writing the first data to the first portion of the virtual block. In some examples, aspects of the operations of 510 may be performed by a data write component 425 as described with reference to FIG. 4.

At 515, the method may include reading, in accordance with a random read operation, the first data from the first portion of the virtual block and the second data from the second portion of the virtual block after writing the second data to the second portion of the virtual block. In some examples, aspects of the operations of 515 may be performed by a data read component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for writing first data to a first portion of a virtual block of the memory system, the virtual block associated with a plurality of non-volatile memory dies of the memory system; writing second data to a second portion of the virtual block of the memory system in accordance with writing the first data to the first portion of the virtual block; and reading, in accordance with a random read operation, the first data from the first portion of the virtual block and the second data from the second portion of the virtual block after writing the second data to the second portion of the virtual block.

Aspect 2: The method, apparatus, or non-transitory computer-readable medium of aspect 1, where reading the first data from the first portion of the virtual block and the second data from the second portion of the virtual block includes reading respective portions of the first data and the second data from each memory die of the plurality of non-volatile memory dies associated with the virtual block.

Aspect 3: The method, apparatus, or non-transitory computer-readable medium of any of aspects 1 through 2, further including operations, features, circuitry, logic, means, or instructions, or any combination thereof for erasing the first data from the first portion of the virtual block and the second data from the second portion of the virtual block as part of a single maintenance operation.

Aspect 4: The method, apparatus, or non-transitory computer-readable medium of aspect 3, where erasing the first data from the first portion of the virtual block and the second data from the second portion of the virtual block includes operations, features, circuitry, logic, means, or instructions, or any combination thereof for erasing the first data from the first portion of the virtual block during a first portion of the single maintenance operation and erasing the second data from the second portion of the virtual block during a second portion of the single maintenance operation.

Aspect 5: The method, apparatus, or non-transitory computer-readable medium of any of aspects 1 through 4, further including operations, features, circuitry, logic, means, or instructions, or any combination thereof for reading, in accordance with a first sequential read operation, the first data from the first portion of the virtual block and reading, in accordance with a second sequential read operation different than the first sequential read operation, the second data from the second portion of the virtual block.

Aspect 6: The method, apparatus, or non-transitory computer-readable medium of any of aspects 1 through 5, further including operations, features, circuitry, logic, means, or instructions, or any combination thereof for receiving a first write command, where writing the first data to the first portion of the virtual block is in accordance with receiving the first write command and receiving a second write command, where writing the second data to the second portion of the virtual block is in accordance with receiving the second write command.

Aspect 7: The method, apparatus, or non-transitory computer-readable medium of any of aspects 1 through 6, further including operations, features, circuitry, logic, means, or instructions, or any combination thereof for receiving a random read command after writing the second data to the second portion of the virtual block, where reading the first data from the first portion of the virtual block and the second data from the second portion of the virtual block is in accordance with receiving the random read command.

Aspect 8: The method, apparatus, or non-transitory computer-readable medium of any of aspects 1 through 7, where the first portion of the virtual block and the second portion of the virtual block are each associated with a respective subset of the plurality of non-volatile memory dies of the memory system.

Aspect 9: The method, apparatus, or non-transitory computer-readable medium of aspect 8, where each respective subset of the plurality of non-volatile memory dies of the memory system includes a same quantity of memory dies.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
write first data to a first portion of a virtual block of the memory system, the virtual block associated with a plurality of non-volatile memory dies of the memory system;
write second data to a second portion of the virtual block of the memory system in accordance with writing the first data to the first portion of the virtual block; and
read, in accordance with a random read operation, the first data from the first portion of the virtual block and the second data from the second portion of the virtual block after writing the second data to the second portion of the virtual block.

2. The memory system of claim 1, wherein reading the first data from the first portion of the virtual block and the second data from the second portion of the virtual block comprises reading respective portions of the first data and the second data from each memory die of the plurality of non-volatile memory dies associated with the virtual block.

3. The memory system of claim 1, wherein the processing circuitry is further configured to cause the memory system to:
erase the first data from the first portion of the virtual block and the second data from the second portion of the virtual block as part of a single maintenance operation.

4. The memory system of claim 3, wherein erasing the first data from the first portion of the virtual block and the second data from the second portion of the virtual block comprises the processing circuitry configured to cause the memory system to:
erase the first data from the first portion of the virtual block during a first portion of the single maintenance operation; and
erase the second data from the second portion of the virtual block during a second portion of the single maintenance operation.

5. The memory system of claim 1, wherein the processing circuitry is further configured to cause the memory system to:
read, in accordance with a first sequential read operation, the first data from the first portion of the virtual block; and
read, in accordance with a second sequential read operation different than the first sequential read operation, the second data from the second portion of the virtual block.

6. The memory system of claim 1, wherein the processing circuitry is further configured to cause the memory system to:
receive a first write command, wherein writing the first data to the first portion of the virtual block is in accordance with receiving the first write command; and
receive a second write command, wherein writing the second data to the second portion of the virtual block is in accordance with receiving the second write command.

7. The memory system of claim 1, wherein the processing circuitry is further configured to cause the memory system to:
receive a random read command after writing the second data to the second portion of the virtual block, wherein reading the first data from the first portion of the virtual block and the second data from the second portion of the virtual block is in accordance with receiving the random read command.

8. The memory system of claim 1, wherein the first portion of the virtual block and the second portion of the virtual block are each associated with a respective subset of the plurality of non-volatile memory dies of the memory system.

9. The memory system of claim 8, wherein each respective subset of the plurality of non-volatile memory dies of the memory system comprises a same quantity of memory dies.

10. A non-transitory computer-readable medium storing code comprising instructions which, when executed by processing circuitry of a memory system, cause the memory system to:
write first data to a first portion of a virtual block of the memory system, the virtual block associated with a plurality of non-volatile memory dies of the memory system;
write second data to a second portion of the virtual block of the memory system in accordance with writing the first data to the first portion of the virtual block; and
read, in accordance with a random read operation, the first data from the first portion of the virtual block and the second data from the second portion of the virtual block after writing the second data to the second portion of the virtual block.

11. The non-transitory computer-readable medium of claim 10, wherein reading the first data from the first portion of the virtual block and the second data from the second portion of the virtual block comprises reading respective portions of the first data and the second data from each memory die of the plurality of non-volatile memory dies associated with the virtual block.

12. The non-transitory computer-readable medium of claim 10, wherein the instructions, when executed by the processing circuitry of the memory system, further cause the memory system to:
erase the first data from the first portion of the virtual block and the second data from the second portion of the virtual block as part of a single maintenance operation.

13. The non-transitory computer-readable medium of claim 12, wherein the instructions to erase the first data from the first portion of the virtual block and the second data from the second portion of the virtual block, when executed by the processing circuitry of the memory system, further cause the memory system to:
erase the first data from the first portion of the virtual block during a first portion of the single maintenance operation; and
erase the second data from the second portion of the virtual block during a second portion of the single maintenance operation.

14. The non-transitory computer-readable medium of claim 10, wherein the instructions, when executed by the processing circuitry of the memory system, further cause the memory system to:
read, in accordance with a first sequential read operation, the first data from the first portion of the virtual block; and
read, in accordance with a second sequential read operation different than the first sequential read operation, the second data from the second portion of the virtual block.

15. The non-transitory computer-readable medium of claim 10, wherein the instructions, when executed by the processing circuitry of the memory system, further cause the memory system to:
receive a first write command, wherein writing the first data to the first portion of the virtual block is in accordance with receiving the first write command; and
receive a second write command, wherein writing the second data to the second portion of the virtual block is in accordance with receiving the second write command.

16. The non-transitory computer-readable medium of claim 10, wherein the instructions, when executed by the processing circuitry of the memory system, further cause the memory system to:
receive a random read command after writing the second data to the second portion of the virtual block, wherein reading the first data from the first portion of the virtual block and the second data from the second portion of the virtual block is in accordance with receiving the random read command.

17. The non-transitory computer-readable medium of claim 10, wherein the first portion of the virtual block and the second portion of the virtual block are each associated with a respective subset of the plurality of non-volatile memory dies of the memory system.

18. The non-transitory computer-readable medium of claim 17, wherein each respective subset of the plurality of non-volatile memory dies of the memory system comprises a same quantity of memory dies.

19. A method at a memory system, comprising:
writing first data to a first portion of a virtual block of the memory system, the virtual block associated with a plurality of non-volatile memory dies of the memory system;
writing second data to a second portion of the virtual block of the memory system in accordance with writing the first data to the first portion of the virtual block; and
reading, in accordance with a random read operation, the first data from the first portion of the virtual block and the second data from the second portion of the virtual block after writing the second data to the second portion of the virtual block.

20. The method of claim 19, wherein reading the first data from the first portion of the virtual block and the second data from the second portion of the virtual block comprises reading respective portions of the first data and the second data from each memory die of the plurality of non-volatile memory dies associated with the virtual block.

21. The method of claim 19, further comprising:
erasing the first data from the first portion of the virtual block and the second data from the second portion of the virtual block as part of a single maintenance operation.

22. The method of claim 21, wherein erasing the first data from the first portion of the virtual block and the second data from the second portion of the virtual block comprises:
erasing the first data from the first portion of the virtual block during a first portion of the single maintenance operation; and
erasing the second data from the second portion of the virtual block during a second portion of the single maintenance operation.
